(19) United States
(12) Patent Application Publication
(10) Pub. No.: US 2026/0257693 A1
(43) Pub. Date: Sep. 3, 2026

(54) ELECTRONIC DEVICE, METHOD, AND NON-TRANSITORY COMPUTER-READABLE STORAGE MEDIUM FOR PROTECTING USER SAFETY

(71) Applicant: THINKWARE CORPORATION, Seongnam-si (KR)

(72) Inventors: Sukpil KO, Seongnam-si (KR); Dongwon SHIN, Seongnam-si (KR); Jungung HA, Seongnam-si (KR)

(21) Appl. No.: 19/552,275

(22) Filed: Feb. 27, 2026

(30) Foreign Application Priority Data
Feb. 28, 2025 (KR) 10-2025-0026724
Feb. 28, 2025 (KR) 10-2025-0026726
Feb. 25, 2026 (KR) 10-2026-0035067

(51) Int. Cl. B60W 50/14; B60W 30/08; G06V 20/58; G06V 20/59

(52) U.S. Cl. CPC B60W 50/14; B60W 30/08; G06V 20/58; G06V 20/59; B60W 2050/143

(57) ABSTRACT

An electronic device is described. The electronic device is mountable on a vehicle. The electronic device includes a camera configured to be disposed to face an interior of the vehicle, memory, and a processor. The processor is configured to cause the electronic device to obtain a video via the camera, identify a visual object by performing object recognition on the video, based on identifying the visual object corresponding to an external object of a designated category, determine a reference position of the visual object within the video, while obtaining the video, identify whether the reference position which is tracked from the video is located outside a safety area that defines the interior of the vehicle, and output an alarm related to the external object based on identifying that the reference position of the visual object is located outside the safety area.

### TECHNICAL FIELD

The present disclosure relates to an electronic device, a method, and non-transitory computer-readable storage medium for protecting user safety.

### BACKGROUND

As a cart operated in an autonomous driving method is introduced, interest in technology that may secure safety of an occupant even without driver intervention is increasing. In this unmanned cart environment, technology recognizing a user's position and state in an interior of a vehicle in real time and actively determining a situation related to safety is required. Accordingly, technology that supports safe driving by analyzing the user's state based on a video inside the vehicle is gradually receiving attention.

The above-described information may be provided as a related art for the purpose of helping understanding of the present disclosure. No argument or decision is made as to whether any of the above description may be applied as a prior art related to the present disclosure.

### SUMMARY

An electronic device is described. The electronic device may be mountable on a vehicle. The electronic device may comprise a camera configured to be disposed to face an interior of the vehicle, memory, and a processor. The processor may be configured to cause the electronic device to obtain a video via the camera, identify a visual object by performing object recognition on the video, based on identifying the visual object corresponding to an external object of a designated category, determine a reference position of the visual object within the video, while obtaining the video, identify whether the reference position which is tracked from the video is located outside a safety area that defines the interior of the vehicle, and output an alarm related to the external object based on identifying that the reference position of the visual object is located outside the safety area.

A method is described. The method may be executed by an electronic device mountable on a vehicle and comprising a camera configured to be disposed to face an interior of the vehicle, memory, and a processor. The method may comprise obtaining a video via the camera, identifying a visual object by performing object recognition on the video, based on identifying the visual object corresponding to an external object of a designated category, determining a reference position of the visual object within the video, while obtaining the video, identifying whether the reference position which is tracked from the video is located outside a safety area that defines the interior of the vehicle, and outputting an alarm related to the external object based on identifying that the reference position of the visual object is located outside the safety area.

A non-transitory computer-readable storage medium is described. The non-transitory computer-readable storage medium may store one or more programs. The one or more programs may be executed by an electronic device mountable on a vehicle and comprising a camera configured to be disposed to face an interior of the vehicle, memory, and a processor. The one or more programs may include instructions that cause the electronic device to obtain a video via the camera, identify a visual object by performing object recognition on the video, based on identifying the visual object corresponding to an external object of a designated category, determine a reference position of the visual object within the video, while obtaining the video, identify whether the reference position which is tracked from the video is located outside a safety area that defines the interior of the vehicle, and output an alarm related to the external object based on identifying that the reference position of the visual object is located outside the safety area.

### BRIEF DESCRIPTION OF DRAWINGS

FIG. 1 is a simplified block diagram of an electronic device of the present invention.

FIG. 2 is a schematic diagram of a vehicle on which an electronic device of FIG. 1 is mounted.

FIG. 3 illustrates an image corresponding to a video obtained via an internal camera of FIG. 1.

FIG. 4 illustrates an embodiment of performing object recognition on an image of FIG. 3.

FIG. 5A illustrates an embodiment in which a reference position of a visual object of FIG. 3 is located within a safety area.

FIG. 5B illustrates an embodiment in which a reference position of a visual object of FIG. 3 is located outside a safety area.

FIG. 6 is a flowchart representing an embodiment of an operation of an electronic device of FIG. 1.

FIG. 7 illustrates an image corresponding to a video obtained via an external camera of FIG. 1.

FIG. 8 is a flowchart illustrating an embodiment of transmitting data to an external electronic device via a communication circuit of FIG. 1.

FIG. 9 illustrates an example of a block diagram illustrating an autonomous driving system of a vehicle according to an embodiment.

FIG. 10 and FIG. 11 illustrate an example of a block diagram representing an autonomous driving mobile body according to an embodiment.

FIG. 12 illustrates an example of a gateway associated with a user device according to various embodiments.

FIG. 13 is a diagram for describing an operation of an electronic device training a neural network based on a set of training data according to an embodiment.

FIG. 14 is a block diagram of an electronic device according to an embodiment.

### DETAILED DESCRIPTION

In the following drawings, identical, similar, or corresponding reference numerals may be assigned to an identical, similar, or corresponding configuration, and duplicated descriptions thereof may not be repeated. In the description with reference to a specific drawing below, reference numerals of other drawings may be referred to.

In the present specification, an expression “A, B, or C (A, B, or C)” is used in an inclusive sense including “A”, “B”, “C”, or “any combination thereof”, unless clearly stated otherwise in the context. In addition, an expression “at least one of A, B, and C” should be interpreted to include a meaning including “A alone”, “B alone”, “C alone”, or “any combination of two or more of A, B, and C”, and selectively including respective components, even though a grammatical conjunction ‘and’ is used. Furthermore, such a definition is applied in the same manner even in a case that the number of the described elements is three or more.

In the present disclosure, a description “A, B, and/or C” is merely a simplified expression for brevity of a sentence, and should be interpreted as being identical to a case in which each of “A alone”, “B alone”, “C alone”, “A and B”, “A and C”, “B and C”, and “A, B, and C as a whole” is individually and specifically described. For example, a description that a component includes “A, B, and/or C” should be interpreted as being identical to that the component may selectively include “A”, may include “B”, may include “C”, may include “A and B”, may include “A and C”, may include “B and C”, or may include “A, B, and C”.

In the present disclosure, a singular expression includes a plurality of objects, unless clearly indicated otherwise in the context, and a plural expression is also intended to include a singular object, unless clearly indicated otherwise in the context. For example, a reference to “an element” includes “one or more elements”, and a reference to “elements” may include “one element”.

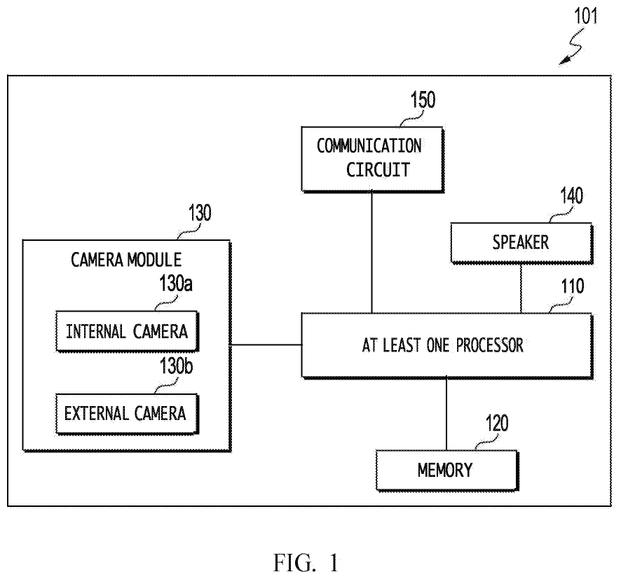

FIG. 1 is a simplified block diagram of an electronic device of the present invention.

Referring to FIG. 1, an electronic device 100 may include at least one processor 110, memory 120, a camera module 130, a speaker 140, and a communication circuit 150. An embodiment of the present disclosure is not limited thereto. The electronic device 100 may further include other components in addition to the above-described components.

The at least one processor 110 may be an application processor (AP) implemented as a system-on-chip (SoC) in the electronic device 100, but is not limited thereto. The at least one processor 110 may perform operations according to embodiments of the present disclosure by executing instructions stored in the memory 120. The at least one processor 110 may execute or control one or more software modules, firmware, and/or hardware logic. In an embodiment, the at least one processor 110 may identify a visual object included within a video or determine an event related to an accident by executing a trained model.

The memory 120 may include one or more storage media, and may store instructions executed by the processor 110. The memory 120 may store various programs and data executed by the at least one processor 110. For example, the memory 120 may include a volatile memory such as a random-access memory (RAM), and/or a non-volatile memory such as read-only memory (ROM). The volatile memory may include, for example, at least one of a dynamic RAM (DRAM), a static RAM (SRAM), a cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, and an embedded multimedia card (EMMC).

The camera module 130 may capture an external subject. The camera module 130 may receive external light and transmit data related to the light to the at least one processor 110. The camera module 130 may include an internal camera 130a configured to be disposed to face an interior of a vehicle and an external camera 130b configured to be disposed to face an exterior of the vehicle. The internal camera 130a may obtain a video corresponding to a position, a posture, and/or a motion of a user by capturing the user riding in the vehicle. The external camera 130b may obtain a video related to a driving environment and/or a surrounding situation of the vehicle by capturing an exterior environment of the vehicle. A video obtained via the internal camera 130a and the external camera 130b may be transmitted to the at least one processor 110 in a form of video data and/or image data.

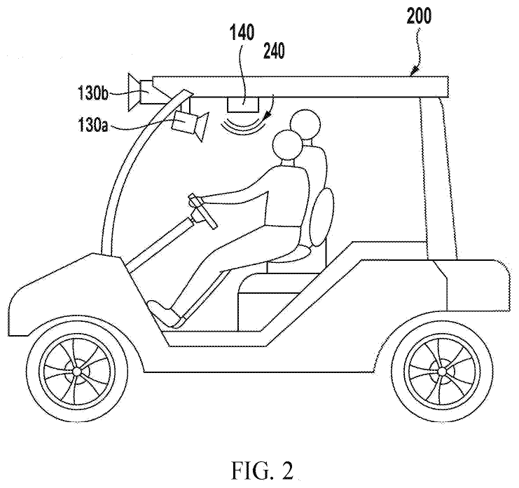

The speaker 140 may output a voice signal or a sound signal according to an operation of the electronic device 100. For example, the speaker 140 may be configured to output a guide voice, an alarm sound, or another sound signal to the user according to control of the processor 110. In an embodiment, the speaker 140 may provide an alarm (e.g., an alarm 240 of FIG. 2) for causing the user riding in a vehicle (e.g., a vehicle 200 of FIG. 2) to recognize a current state or for calling attention of the user.

The communication circuit 150 may perform wired and wireless communication with an external electronic device. The communication circuit 150 may be controlled by the at least one processor 110. In an embodiment, the communication circuit 150 may be configured to support short-range wireless communication, mobile communication, or another communication method. The communication circuit 150 may enable data transmission and reception between the electronic device 100 and an external electronic device.

FIG. 2 is a schematic diagram of a vehicle on which an electronic device of FIG. 1 is mounted.

Referring to FIG. 2, configurations of the electronic device 100 of FIG. 1 may be mounted on a vehicle 200. The vehicle 200 may be controlled by at least one processor 110 of the electronic device 100 or may operate in conjunction with the electronic device 100. In an embodiment, the vehicle 200 may include a cart operated without a driver, an autonomous driving vehicle, and/or a remote-controlled vehicle. However, an embodiment of the present disclosure is not limited thereto.

In an embodiment, an internal camera 130a may be disposed in an interior of the vehicle 200. The internal camera 130a may be disposed in a front of a seat, a side, or near a ceiling so as to be capable of capturing a user riding in the vehicle 200. An external camera 130b may be disposed in an exterior of the vehicle 200, and the external camera 130b may be disposed in at least one position among a front, a side, and a rear of the vehicle 200. However, an embodiment of the present disclosure is not limited thereto.

For example, the internal camera 130a may be configured to capture the interior of the vehicle by being disposed in the exterior of the vehicle 200, and the external camera 130b may be configured to capture the exterior environment of the vehicle by being disposed in the interior of the vehicle 200. Although one internal camera 130a and one external camera 130b are illustrated in FIG. 2, an embodiment of the present disclosure is not limited thereto. Each of the internal camera 130a and the external camera 130b may include a plurality of cameras.

In an embodiment, a speaker 140 may be mounted on the vehicle 200. The speaker 140 may be disposed in the interior and/or the exterior of the vehicle 200, and may output an alarm 240 including a voice or sound signal to the user riding in the vehicle 200. The alarm 240 may include guide information or attention calling information provided to the user while the vehicle 200 is driving.

For example, the alarm 240 may be an alarm signal provided for safety of the user. For example, the alarm 240 may include a voice guide, a warning sound, or another sound signal for causing the user to recognize a situation related to safety that may occur in the interior of the vehicle 200. However, an embodiment of the present disclosure is not limited thereto. A form, a content, or an output method of the alarm 240 may be configured in various ways.

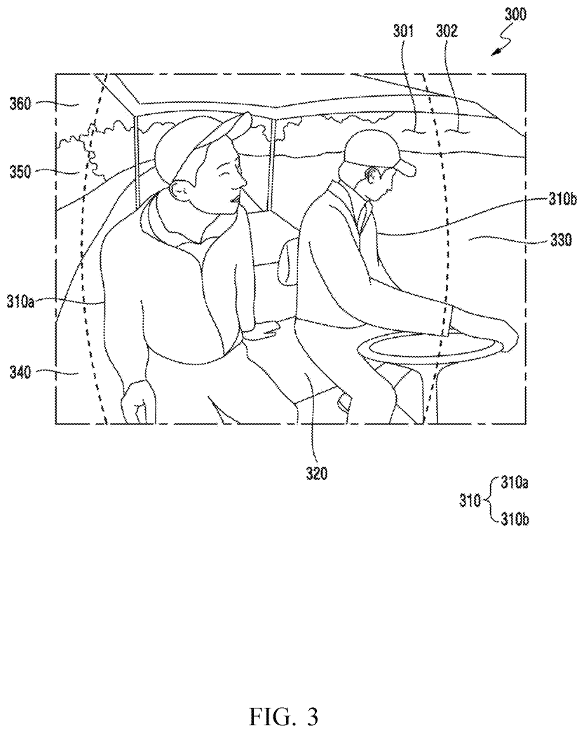

FIG. 3 illustrates an image corresponding to a video obtained via an internal camera of FIG. 1. Specifically, an image 300 illustrated in FIG. 3 represent, for convenience of description, an image corresponding to a video frame at a specific time point of a video obtained via an internal camera 130a. For example, FIG. 3 illustrates an image in a state in which an occupant is riding in an interior of a vehicle 200.

Referring to FIG. 3, the internal camera 130a may be configured to capture the interior of the vehicle 200 by being disposed to face the interior of the vehicle 200. The internal camera 130a may be referred to as an interior dashcam.

The image 300 obtained by capturing via the internal camera 130a may include a plurality of visual objects. The plurality of visual objects may include first to sixth visual objects 310, 320, 330, 340, 350, and 360.

For example, the first visual object 310 may correspond to an occupant riding in the vehicle 200. For example, the first visual object 310 may include a 1-1 visual object 310a corresponding to an occupant riding in a driver seat and a 1-2 visual object 310b corresponding to an occupant riding in a passenger seat. However, the first visual object 310 may include one or three or more visual objects. The first visual object 310 may be referred to, in the present specification, as a target object and/or a tracking object tracked for safety of the occupant.

The second visual object 320 may correspond to configurations in the interior of the vehicle 200. For example, the second visual object 320 may be an object corresponding to a seat, a steering wheel, and the like in the interior of the vehicle. The third visual object 330 may correspond to grass. The fourth visual object 340 may correspond to a road. The fifth visual object 350 may correspond to a tree. The sixth visual object 360 may correspond to sky. Each of the second to sixth visual objects 320, 330, 340, 350, and 360 may be referred to, in the present specification, as a non-target object and/or a non-tracking object.

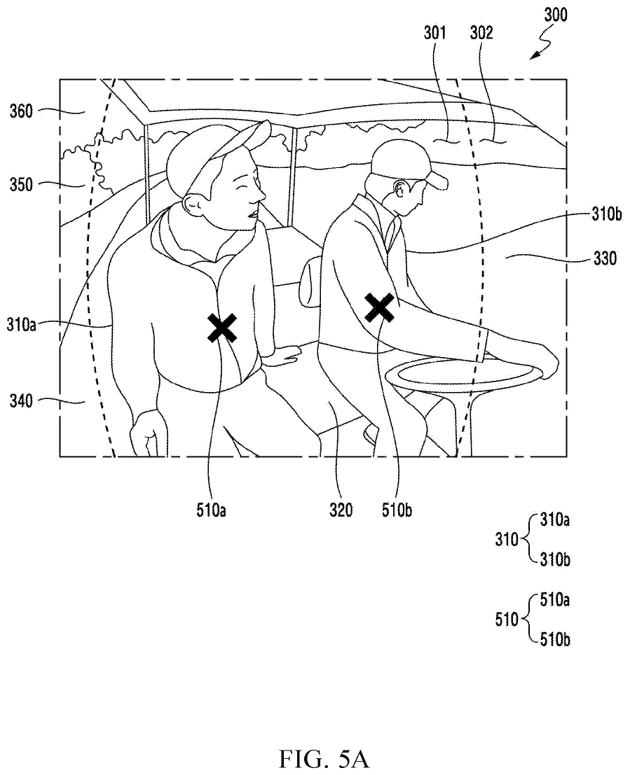

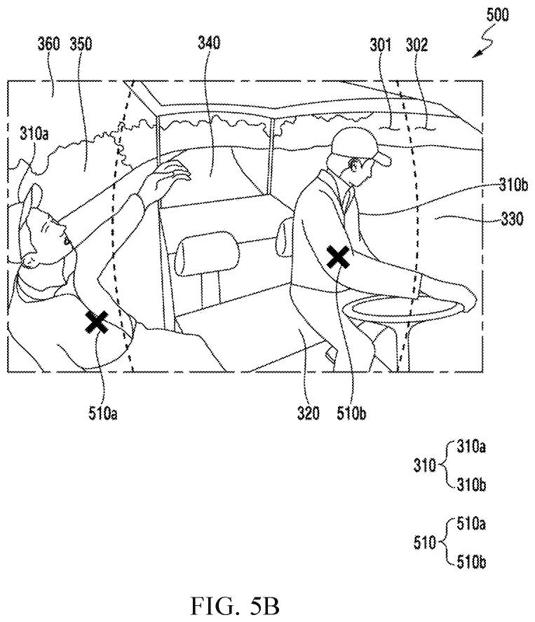

In an embodiment, the image 300 included within the video may define a safety area 301 and a non-safety area 302. The safety area 301 may be defined corresponding to the interior of the vehicle 200 and/or a normal riding position. The safety area 301 may correspond to the interior of the vehicle 200, and the non-safety area 302 may correspond to an exterior of the vehicle 200. At least one processor 110 may identify whether a reference position (e.g., a reference position 510 of FIG. 5A) of each of the first visual objects 310 is located outside the safety area 301.

In an embodiment, the at least one processor 110 may identify a spatial structure in the interior of the vehicle 200 by estimating depth information regarding the image 300 included within the video. For example, the at least one processor 110 may generate a depth map based on a video obtained by a camera module 130, and may identify, by using the depth map, a position and a range in which an occupant normally seats in the interior of the vehicle 200. Via the depth map, the at least one processor 110 may define an area in which riding safety is maintained as the safety area 301.

In an embodiment, when identifying that the first visual object 310 is located in the safety area 301, the at least one processor 110 may determine that riding safety of the occupant corresponding to the first visual object 310 is normally maintained in the vehicle 200.

On the other hand, when identifying that the first visual object 310 is located outside the safety area 301, the at least one processor 110 may determine that riding safety of the occupant corresponding to the first visual object 310 is not normally maintained in the vehicle 200. For example, when the reference position (e.g., the reference position 510 of FIG. 5A) of the first visual object 310 is located in the non-safety area 302, the at least one processor 110 may determine that the occupant corresponding to the first visual object 310 has deviated from a normal riding position in the vehicle 200 or is in a state in which riding safety is not maintained.

As autonomous driving vehicles or vehicles operated unmanned are recently gradually increasing, importance of technology capable of recognizing a state of an occupant and guiding a situation related to safety without direct intervention of a driver or a manager in an operation process of the vehicle 200 is increasing. In this vehicle environment, an operation of checking whether an occupant is safely riding in the vehicle 200 by analyzing a video obtained via a camera module (e.g., the camera module 130 of FIG. 1) may be required. Accordingly, the at least one processor 110 needs to perform an action for protecting safety of a user even in an autonomous driving vehicle or unmanned vehicle environment, by providing an alarm 240 capable of causing an occupant to recognize a corresponding state via the speaker 140 or reducing a moving speed of the vehicle 200.

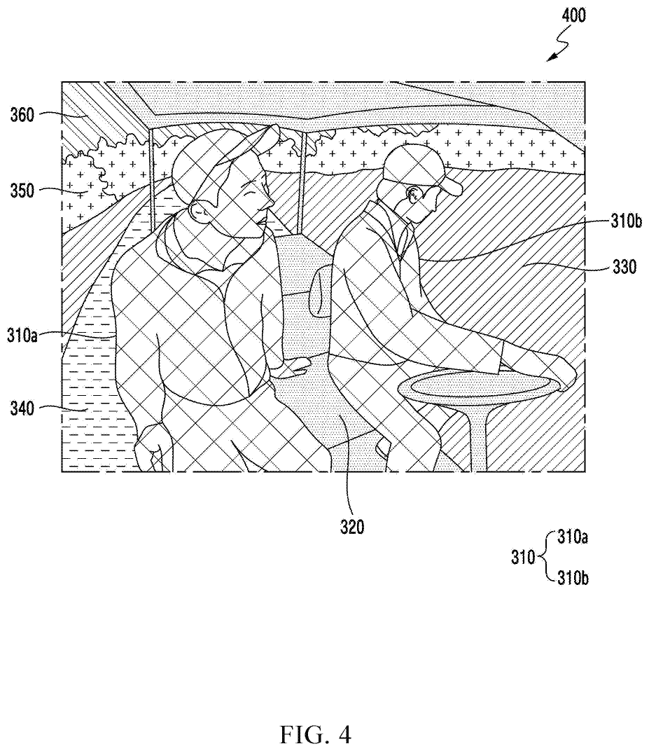

FIG. 4 illustrates an embodiment of performing object recognition on an image of FIG. 3. Description with reference to FIG. 4 may partially overlap description with reference to FIG. 3. Accordingly, an overlapping content may be omitted or simplified.

An image 400 illustrated in FIG. 4 represents a result of expressing a plurality of visual objects included in the image 300 of FIG. 3 by distinguishing them from each other. More specifically, the image 400 of FIG. 4 illustrates an embodiment of performing object recognition for identifying a boundary of each of visual objects included within a video and distinguishing each of visual objects 310, 320, 330, 340, 350, and 360 according to the boundary. More specifically, the image 400 of FIG. 4 illustrates an embodiment of performing object recognition, for example, image segmentation, for identifying the boundary of each of the visual objects included within the video and segmenting each of the visual objects 310, 320, 330, 340, 350, and 360 according to the boundary.

Referring to FIG. 4, at least one processor 110 may distinguish areas corresponding to a shape of a person, an interior structure of a vehicle, and/or an exterior background of the vehicle included within the video as different visual objects. The at least one processor 110 may perform an object recognition operation for the visual objects 310, 320, 330, 340, 350, and 360.

The boundary of each of the visual objects 310, 320, 330, 340, 350, and 360 may be identified by the at least one processor 110 so as to be distinguished from an adjacent area, and the boundary may indicate area separation between adjacent visual objects. For example, as illustrated in FIG. 4, the first visual object 310 corresponding to a shape of a person may have a boundary distinguished from the second to sixth visual objects 320, 330, 340, 350, and 360 corresponding to the interior structure of the vehicle or the exterior background of the vehicle.

According to embodiments of the present disclosure, by distinguishing the plurality of visual objects through object recognition as described above, the at least one processor 110 may clearly distinguish the first visual object 310 corresponding to an occupant and other background objects (e.g., the second to sixth visual objects 320, 330, 340, 350, and 360). For example, the first visual object 310 corresponding to the shape of the person may be set as a target object continuously tracked for determination related to safety of the occupant. On the other hand, the second to sixth visual objects 320, 330, 340, 350, and 360 corresponding to the interior structure of the vehicle or an exterior environment of the vehicle may be classified as a non-target object.

In an embodiment, accurately identifying the first visual object 310 as the target object and distinguishing it from other visual objects may be a preliminary step for stably calculating and tracking a reference position (e.g., a reference position 510 of FIG. 5A) of the first visual object 310 thereafter. That is, when the first visual object 310 is not clearly distinguished from the second to sixth visual objects 320, 330, 340, 350, and 360, it may be difficult to reliably calculate the reference position 510 of the first visual object 310.

Accordingly, an object recognition step illustrated in FIG. 4 may function as a basic step for finally tracking the reference position (510 of FIG. 5A) of the first visual object 310 and providing an alarm 240 according to a relationship between the reference position (510 of FIG. 5A) and a safety area 301.

Meanwhile, in FIG. 4, object recognition in an image segmentation method of segmenting boundaries of visual objects has been described as an example, but an embodiment of the present disclosure is not limited thereto. For example, the at least one processor 110 may identify a visual object by using an object detection method of detecting, in a box shape, a visual object corresponding to a person as in the provided image. Even in this case, the first visual object 310 may be identified as the target object distinguished from other objects.

FIG. 5A illustrates an embodiment in which a reference position of a visual object of FIG. 3 is located within a safety area. FIG. 5B illustrates an embodiment in which a reference position of a visual object of FIG. 3 is located outside a safety area. Description with reference to FIGS. 5A and 5B may partially overlap description with reference to FIG. 3. Accordingly, an overlapping content may be omitted or simplified.

Referring to FIG. 5A and FIG. 5B, at least one processor 110 may define a reference position 510 of a first visual object 310 appearing in an image 300. For example, the at least one processor 110 may define a 1-1 reference position 510a of a 1-1 visual object 310a. The at least one processor 110 may define a 1-2 reference position 510b of a 1-2 visual object 310b.

In an embodiment, when identifying that the first visual object 310 corresponds to a person, the at least one processor 110 may estimate a center of mass of the first visual object 310 through human body posture estimation. For example, by executing a trained posture estimation model, the at least one processor 110 may identify a position of a major joint or a body part of a human body, such as a head, a body, an arm, a leg, and the like of a person, and calculate a position corresponding to the center of mass of the first visual object 310 as the reference position 510 based on the positions of the plurality of identified body parts. This reference position 510 may be updated in real time by reflecting a seating state and/or a posture change of an occupant.

In an embodiment, the reference position 510 may correspond to the center of mass of the first visual object 310. For example, the 1-1 reference position 510a may correspond to a center of mass of the 1-1 visual object 310a. The 1-2 reference position 510b may correspond to a center of mass of the 1-2 visual object 310b. However, an embodiment of the present disclosure is not limited thereto. The reference position 510 may correspond to a position calculated by tracking a specific position of the human body in a sitting posture of the first visual object 310 in a vehicle 200. The specific position may include a position corresponding to a pelvis or a solar plexus of the human body.

As illustrated in FIG. 5A, when the reference position 510 of the first visual object 310 is identified as being located in a safety area 301, the at least one processor 110 may determine that the occupant is in a state of being in a safe position in an interior of a vehicle. In this case, since a position of the occupant is maintained in the safety area 301 defining the interior of the vehicle, the at least one processor 110 may not provide a separate alarm (e.g., the alarm 240 of FIG. 2) to a user. For example, when the occupant is in a state of normally sitting in a seat or is maintaining a stable position in the interior of the vehicle, the alarm 240 may not be provided.

On the other hand, as illustrated in an image 500 of FIG. 5B, when the reference position 510 of the first visual object 310 is identified as being located outside the safety area 301, the at least one processor 110 may determine that a position of the occupant is in a state of being outside the safety area defining the interior of the vehicle. For example, the position of the occupant is in a state of being outside the safety area may correspond to a case that the occupant deviates from the seat, moves toward an exterior direction of the vehicle while the vehicle is driving, or departs from a range defined as the safety area 301 of the vehicle 200. Based on this determination, the at least one processor 110 may provide the alarm 240 to the user via a speaker (e.g., the speaker 140 of FIG. 2). The alarm 240 may be provided as an alarm for causing the occupant to recognize a current position state, and may call attention of the user while the vehicle is driving.

In an embodiment, the alarm 240 may be output in a form of a voice or sound signal via the speaker 140 illustrated in FIG. 1. The voice or sound signal may include a message, a warning sound, or a sound for calling attention, for guiding a state related to safety to the occupant. Accordingly, even in an autonomous driving vehicle or an environment in which a vehicle is operated in an unmanned manner, the occupant may recognize the occupant's current state.

In an embodiment, when the reference position 510 of the first visual object 310 is identified as being located outside the safety area 301, the at least one processor 110 may control the vehicle 200 to reduce a moving speed of the vehicle 200. For example, the at least one processor 110 may control to gradually reduce a driving speed of the vehicle 200 in conjunction with a driving system or a control system of the vehicle 200.

The reduction of the moving speed may include an operation of completely stopping the vehicle 200. For example, when the reference position 510 of the first visual object 310 is identified as being continuously located outside the safety area 301, or when it is determined as a state in which safety of the occupant is not maintained, the at least one processor 110 may control the vehicle 200 to stop. The at least one processor 110 may simultaneously perform an operation of providing the alarm 240 via the speaker 140 and an operation of reducing the moving speed by controlling the vehicle 200.

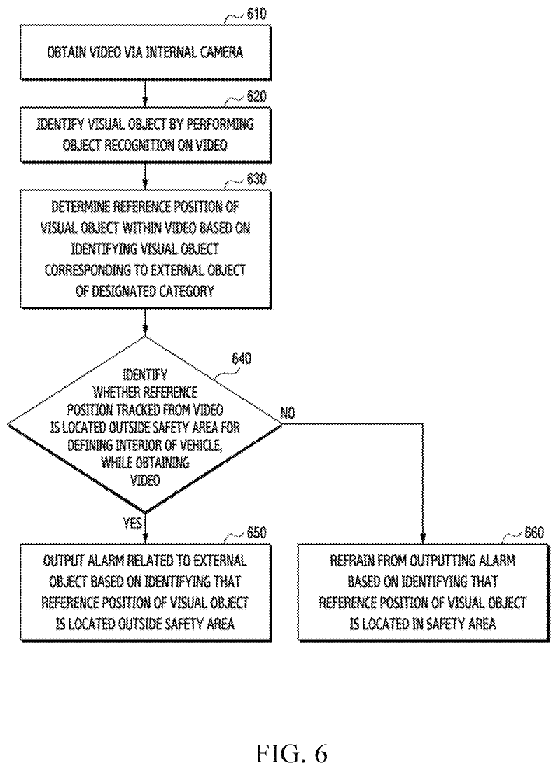

FIG. 6 is a flowchart representing an embodiment of an operation of an electronic device of FIG. 1. Referring to FIG. 6, an operation of an electronic device 100 may be performed by at least one processor 110. The operations may include operations for improving safety of a user riding in an interior of a vehicle 200. Description with reference to FIG. 6 may partially overlap description with reference to FIGS. 2 to 5B. Accordingly, an overlapping content may be omitted or simplified.

Referring to FIG. 6, in operation 610, the at least one processor 110 may obtain a video via an internal camera (e.g., the internal camera 130a of FIG. 2). For example, the at least one processor 110 may receive, from the internal camera 130a disposed to face the interior of the vehicle 200, a video capturing the interior of the vehicle 200. The video may include the user riding in the interior of the vehicle 200, a seat, an interior structure of the vehicle, and the like, and may be used as input data for subsequent object recognition and position determination.

In operation 620, the at least one processor 110 may identify a visual object by performing object recognition on the video. For example, the at least one processor 110 may distinguish areas corresponding to a shape of a person, the interior structure of the vehicle, or a background included within the video as different visual objects. Through this, a visual object (e.g., the first visual object 310 of FIG. 3) corresponding to the user and other objects (e.g., the second to sixth visual objects 320, 330, 340, 350, and 360 of FIG. 3) may be distinguished.

In operation 630, based on identifying the first visual object 310 corresponding to an external object of a designated category, the at least one processor 110 may determine a reference position (e.g., the reference position 510 of FIG. 5A) of the first visual object 310 within the video. The designated category may correspond to a person. For example, the at least one processor 110 may set the first visual object 310 corresponding to the user as a target object, and may determine a position corresponding to a center of mass of the target object as the reference position 510. The reference position 510 may be used as a representative position for determining a relationship between the first visual object 310 and a safety area 301.

In operation 640, while obtaining the video, the at least one processor 110 may identify whether the reference position 510 of the first visual object 310 tracked from the video is located outside the safety area 301 of the vehicle 200. For example, the at least one processor 110 may track movement of the reference position 510 across a plurality of continuous video frames, and may determine whether the reference position 510 departs from a boundary of the predefined safety area 301. Through this, a change in a position of the user may be detected in real time.

In operation 650, based on identifying that the reference position 510 of the first visual object 310 is located outside the safety area 301, the at least one processor 110 may output an alarm 240 via a speaker 140. Based on identifying that the reference position 510 of the first visual object 310 is located outside the safety area 301, the at least one processor 110 may control the vehicle 200 to reduce a moving speed of the vehicle 200 or stop movement of the vehicle 200.

In operation 660, based on identifying that the reference position 510 of the first visual object 310 is located in the safety area 301, the at least one processor 110 may omit outputting the alarm 240. For example, when the user maintains a stable position in the interior of the vehicle 200, the at least one processor 110 may control the speaker 140 such that an unnecessary alarm is not provided.

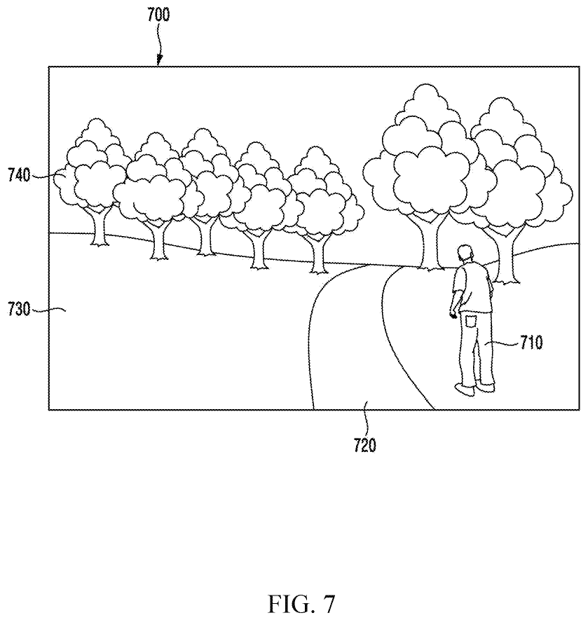

FIG. 7 illustrates an image corresponding to a video obtained via an external camera of FIG. 1. Specifically, an image 700 illustrated in FIG. 7 illustrates, for convenience of description, an image corresponding to a video frame at a specific time point of a video obtained via an external camera (e.g., the external camera 130b of FIG. 1). For example, FIG. 7 illustrates an image in a state in which a person is standing on an exterior of a vehicle 200.

Referring to FIG. 7, at least one processor 110 may obtain a video of an exterior environment of a vehicle via the external camera 130b. The video obtained via the external camera 130b may include a plurality of visual objects. For example, the plurality of visual objects may include first to fourth visual objects 710, 720, 730, and 740.

The first visual object 710 may correspond to a person located in the exterior of the vehicle 200. The first visual object 710 may correspond to an occupant who was riding in the vehicle 200 and then got off. The first visual object 710 may also correspond to an external third party such as a pedestrian moving around the vehicle 200. That is, the first visual object 710 may comprehensively include a visual object corresponding to a person located in the exterior of the vehicle 200. The second visual object 720 may correspond to a road, the third visual object 730 may correspond to grass, and the fourth visual object 740 may correspond to a tree. However, the second to fourth visual objects 720, 730, and 740 are not limited thereto. The second to fourth visual objects 720, 730, and 740 may include various exterior environment elements that may be related to an operation of a vehicle or safety of a person, such as a slope, a lake, a sinkhole, and the like.

In an embodiment, the at least one processor 110 may identify the first visual object 710 corresponding to a person or visual objects corresponding to an exterior environment having a possibility of danger, by performing object recognition on the video obtained via the external camera 130b. In an embodiment, the at least one processor 110 may perform an operation of identifying visual objects by executing a trained model. The trained model may include a model configured to learn a shape, a contour, or a spatial feature of a visual object. The at least one processor 110 may identify, based on the identification result, whether an accident has occurred to the first visual object 710 corresponding to a person. The at least one processor 110 may identify, based on the identification result, whether there is a factor that may be dangerous to the vehicle 200 or an occupant of the vehicle.

In an embodiment, in a case that an exterior environment object having a possibility of occurrence of an accident, such as a slope, a lake, a sinkhole, and the like, is identified, the at least one processor 110 may determine the corresponding situation as a case that an accident has occurred and/or a case that an accident is likely to occur.

When an accident occurs to the first visual object 710 or a factor that may be dangerous to the vehicle 200 or the occupant of the vehicle is identified, the at least one processor 110 may transmit data related to the accident to an external electronic device via a communication circuit (e.g., the communication circuit 150 of FIG. 1). The external electronic device may include a server, a control center, and/or an electronic device of a third party. The data related to the accident may include a video or an image obtained via the external camera 130b, information on whether the accident has occurred, or information related to a possibility of occurrence of the accident.

Accordingly, even in an environment in which a person does not exist around the vehicle 200, such as an unmanned cart or an autonomous driving cart, the at least one processor 110 may transmit data related to the accident to an external electronic device via the communication circuit 150 in a situation in which the accident has occurred or the accident is likely to occur. Through this, a control center or a third party may quickly recognize an accident situation. As the accident situation is quickly recognized, it becomes possible to respond within a golden time, thereby improving safety of a user or a surrounding person.

In the description with reference to FIG. 7, it is primarily described that a content of transmitting data related to an accident via the communication circuit 150 when identifying that an accident occurs to the first visual object 710 or danger occurs to the vehicle 200 via external camera 130b. However, an embodiment of the present disclosure is not limited thereto. The at least one processor 110 may determine whether an accident has occurred by considering together a video obtained via the external camera 130b and a video obtained via an internal camera 130a. The at least one processor 110 may also transmit data related to the accident to an external electronic device via the communication circuit 150 even when identifying that an emergency situation occurs to the occupant riding in the vehicle 200.

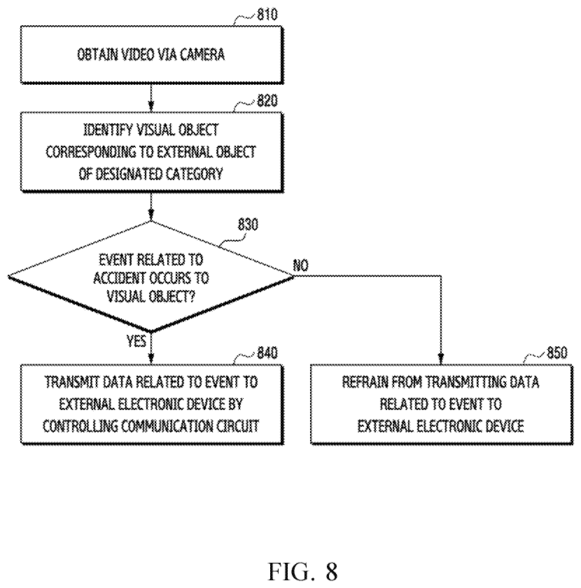

FIG. 8 is a flowchart illustrating an embodiment of transmitting data to an external electronic device via a communication circuit of FIG. 1. An operation of an electronic device 100 may be performed by at least one processor 110. The operations may include a series of processing operations for transmitting, to an external electronic device via a communication circuit 150, information related to an accident occurring on an exterior of a vehicle 200 or a possibility of occurrence of the accident.

Referring to FIG. 8, in operation 810, the at least one processor 110 may obtain a video via a camera module 130. For example, the at least one processor 110 may obtain a video of an exterior environment of the vehicle 200 via an external camera 130b disposed to face the exterior of the vehicle 200. The video may include a person located in the exterior of the vehicle 200 or an exterior environment related to driving of the vehicle 200.

In operation 820, the at least one processor 110 may identify a visual object corresponding to an external object of a designated category. For example, by performing object recognition on the video obtained via the external camera 130b, the at least one processor 110 may identify a first visual object 710 corresponding to a person located in the exterior of the vehicle 200 or a visual object corresponding to an exterior environment having a possibility of occurrence of an accident, such as a slope, a lake, a sinkhole, a tree, and the like.

In operation 830, the at least one processor 110 may identify whether an event related to an accident has occurred to the visual object. For example, the at least one processor 110 may determine, based on a state change or a position change of the first visual object 710 corresponding to a person or a characteristic of an exterior environment object, a case that an accident has occurred and/or a case that an accident is likely to occur. The accident may correspond to an accident occurring to the first visual object 710 located in the exterior of the vehicle or the first visual object (e.g., the first visual object 710 of FIG. 3) located in the interior of the vehicle. The accident may include a situation of overturning and/or collision of the vehicle 200 and/or abnormality in control of the vehicle.

In operation 840, the at least one processor 110 may control the communication circuit to transmit data related to the accident to an external electronic device. For example, the at least one processor 110 may transmit the data related to the accident to a server, a control center, or an electronic device of a third party via the communication circuit 150 illustrated in FIG. 1. The data may include a video or an image obtained via the external camera 130b, information on whether the accident has occurred, or information related to a possibility of occurrence of the accident.

In operation 850, the at least one processor 110 may omit transmitting data related to the event to an external electronic device. For example, when it is determined as a normal state in which an accident has not occurred or there is no possibility of occurrence of an accident, the at least one processor 110 may not perform communication to the external electronic device in order to prevent unnecessary data transmission.

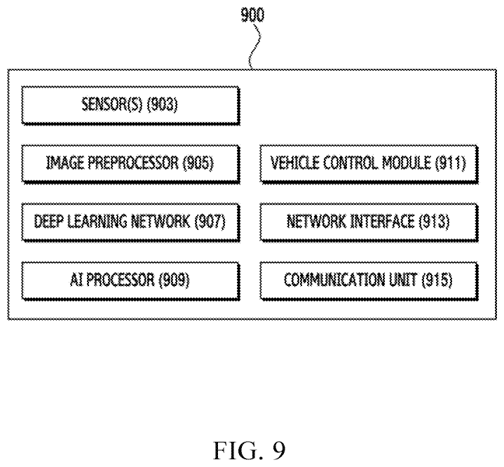

FIG. 9 illustrates an example of a block diagram illustrating an autonomous driving system of a vehicle according to an embodiment.

Referring to FIG. 9, the autonomous driving system 900 of the vehicle according to FIG. 9 may be a deep learning network including sensors 903, an image pre-processor 905, a deep learning network 907, an artificial intelligence (AI) processor 909, a vehicle control module 911, a network interface 913, and a communication unit 915. In various embodiments, each of elements may be connected through various interfaces. For example, sensor data sensed and outputted by the sensors 903 may be fed to the image pre-processor 905. The sensor data processed by the image pre-processor 905 may be fed to the deep learning network 907 run on the AI processor 909. An output of the deep learning network 907 run by the AI processor 909 may be fed to the vehicle control module 911. Intermediate results of the deep learning network 907 run on the AI processor 909 may be fed to the AI processor 909. In various embodiments, the network interface 913 delivers autonomous driving route information and/or autonomous driving control commands for autonomous driving of the vehicle to internal block configurations, by performing communication with an electronic device (e.g., the electronic device 101 of FIG. 1) in the vehicle. In an embodiment, the network interface 913 may be used to transmit the sensor data obtained through the sensor(s) 903 to an external server. In some embodiments, the autonomous driving control system 900 may include additional or fewer components as appropriate. For example, in some embodiments, the image pre-processor 905 may be an optional component. For another example, a post-processing component (not illustrated) may be included in the autonomous driving control system 900 to perform post-processing on the output of the deep learning network 907 before the output is provided to the vehicle control module 911.

In some embodiments, the sensors 903 may include one or more sensors. In various embodiments, the sensors 903 may be attached to different locations of the vehicle. The sensors 903 may face one or more different directions. For example, the sensors 903 may be attached to a front, sides, a rear, and/or a roof of the vehicle to face directions such as forward-facing, rear-facing, and side-facing. In some embodiments, the sensors 903 may be image sensors such as high dynamic range cameras. In some embodiments, the sensors 903 include non-visual sensors. In some embodiments, the sensors 903 include RADAR, Light Detection And Ranging (LiDAR), and/or ultrasonic sensors in addition to an image sensor. In some embodiments, the sensors 903 are not mounted on a vehicle having the vehicle control module 911. For example, the sensors 903 may be included as a portion of a deep learning system for capturing the sensor data and may be attached to an environment or a roadway and/or mounted on nearby vehicles.

In some embodiments, the image pre-processor 905 may be used to pre-process the sensor data of the sensors 903. For example, the image pre-processor 905 may be used to preprocess the sensor data, to split the sensor data into one or more components, and/or to post-process one or more components. In some embodiments, the image pre-processor 905 may be a graphics processing unit (GPU), a central processing unit (CPU), an image signal processor, or a specialized image processor. In various embodiments, the image pre-processor 905 may be a tone-mapper processor for processing high dynamic range data. In some embodiments, the image pre-processor 905 may be a component of the AI processor 909.

In some embodiments, the deep learning network 907 may be a deep learning network for implementing control commands for controlling an autonomous vehicle. For example, the deep learning network 907 may be an artificial neural network such as a Convolutional Neural Network (CNN) trained by using the sensor data, and the output of the deep learning network 907 is provided to the vehicle control module 911.

In some embodiments, the artificial intelligence (AI) processor 909 may be a hardware processor for running the deep learning network 907. In some embodiments, the AI processor 909 is a specialized AI processor for performing inference on the sensor data through the Convolutional Neural Network (CNN). In some embodiments, the AI processor 909 may be optimized for a bit depth of the sensor data. In some embodiments, the AI processor 909 may be optimized for deep learning computations, such as computations of a neural network including a convolution, a dot product, a vector and/or matrix computations. In some embodiments, the AI processor 909 may be implemented through a plurality of graphics processing units (GPUs) capable of effectively performing parallel processing.

In various embodiments, the AI processor 909 may be coupled, through an input/output interface, to memory configured to perform a deep learning analysis on the sensor data received from the sensor(s) 903 while the AI processor 909 is running and to provide an AI processor having commands that cause to determine a machine learning result used to operate the vehicle at least partially autonomously. In some embodiments, the vehicle control module 911 may be used to process commands for vehicle control outputted from the artificial intelligence (AI) processor 909 and translate the output of the AI processor 909 into commands for controlling a module of each vehicle to control various modules of the vehicle. In some embodiments, the vehicle control module 911 is used to control a vehicle for autonomous driving. In some embodiments, the vehicle control module 911 may adjust steering and/or speed of the vehicle. For example, the vehicle control module 911 may be used to control traveling of the vehicle such as deceleration, acceleration, steering, lane change, lane keeping, and the like. In some embodiments, the vehicle control module 911 may generate control signals for controlling vehicle lighting, such as brake lights, turns signals, headlights, and the like. In some embodiments, the vehicle control module 911 may be used to control vehicle audio-related systems such as a vehicle's sound system, vehicle's audio warnings, a vehicle's microphone system, a vehicle's horn system, and the like.

In some embodiments, the vehicle control module 911 may be used to control notification systems, including warning systems to notify passengers and/or a driver of driving events, such as approach of an intended destination or a potential collision. In some embodiments, the vehicle control module 911 may be used to adjust sensors, such as the sensors 903 of the vehicle. For example, the vehicle control module 911 may modify the orientation of the sensors 903, change output resolution and/or a format type of the sensors 903, increase or decrease a capture rate, adjust a dynamic range, and adjust a focus of the camera. In addition, the vehicle control module 911 may turn on/off the operation of sensors individually or collectively.

In some embodiments, the vehicle control module 911 may be used to change parameters of the image pre-processor 905 in a method such as modifying a frequency range of filters, adjusting features and/or edge detection parameters for object detection, or adjusting channels and a bit depth, and the like. In various embodiments, the vehicle control module 911 may be used to control autonomous driving of the vehicle and/or a driver assistance function of the vehicle.

In some embodiments, the network interface 913 may be responsible for an internal interface between block configurations of the autonomous driving control system 900 and the communication unit 915. Specifically, the network interface 913 may be a communication interface for receiving and/or transmitting data including voice data. According to various embodiments, the network interface 913 may be connected to external servers to connect voice calls, receive and/or transmit text messages, transmit sensor data, update software of the vehicle with the autonomous driving system, or update software of the autonomous driving system of the vehicle, through the communication unit 915.

In various embodiments, the communication unit 915 may include various wireless interfaces of cellular or WiFi methods. For example, the network interface 913 may be used to receive an update on operating parameters and/or commands for the sensors 903, the image pre-processor 905, the deep learning network 907, the AI processor 909, and the vehicle control module 911 from an external server connected through the communication unit 915. For example, a machine learning model of the deep learning network 907 may be updated by using the communication unit 915. According to another example, the communication unit 915 may be used to update operating parameters of the image pre-processor 905, such as image processing parameters, and/or firmware of the sensors 903.

In another embodiment, the communication unit 915 may be used to activate communications for an emergency contact and emergency services in an accident or near-accident event. For example, in a crash event, the communication unit 915 may be used to call emergency services for assistance and may be used to externally notify emergency services of crash details and a location of the vehicle. In various embodiments, the communication unit 915 may update or obtain an expected arrival time and/or a destination location.

According to an embodiment, the autonomous driving system 900 illustrated in FIG. 9 may be configured with an electronic device 100 of the vehicle. According to an embodiment, when an autonomous driving release event occurs from a user during autonomous driving of the vehicle, the AI processor 909 of the autonomous driving system 900 may control the software of the vehicle autonomous driving to learn by controlling information related to the autonomous driving release event to be inputted as training set data of the deep learning network.

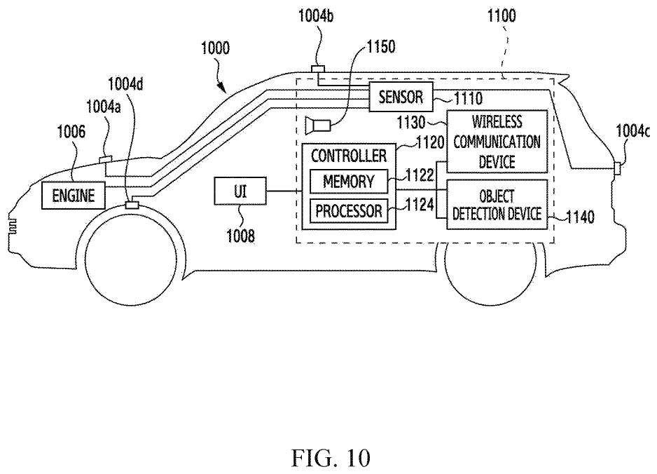

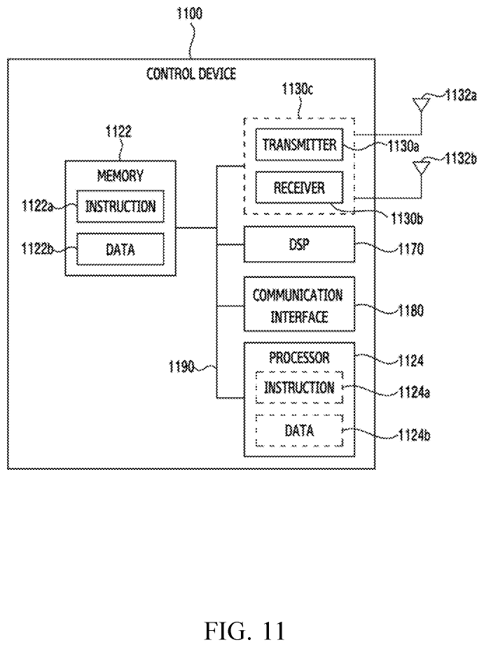

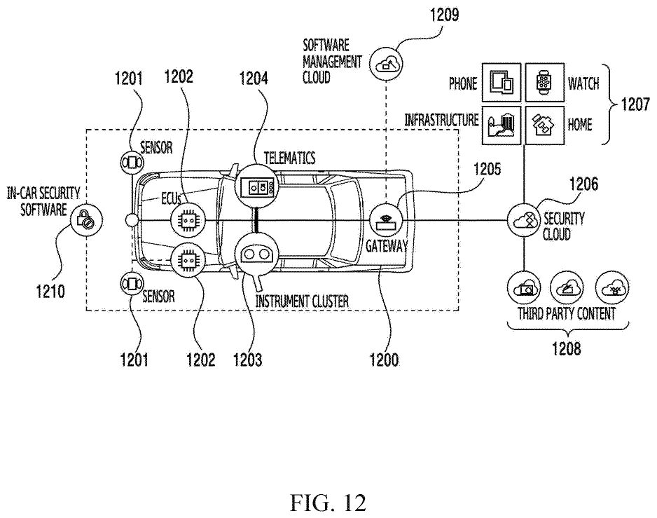

FIGS. 10 and 11 illustrate an example of a block diagram indicating an autonomous driving moving object according to an embodiment. FIG. 12 illustrates an example of a gateway related to a user device according to various embodiments.

Referring to FIG. 10, an autonomous driving moving object 1000 according to the present embodiment may include a control device 1100, sensing modules 1004a, 1004b, 1004c, and 1004d, an engine 1006, and a user interface 1008.

The autonomous driving moving object 1000 may have an autonomous driving mode or a manual mode. As an example, according to a user input received through the user interface 1008, it may be switched from the manual mode to the autonomous driving mode or may be switched from the autonomous driving mode to the manual mode.

In case that the moving object 1000 operates in the autonomous driving mode, the autonomous driving moving object 1000 may operate under control of the control device 1100.

In the present embodiment, the control device 1100 may include a controller 1120, including memory 1122 and a processor 1124, a sensor 1110, a communication device 1130, and an object detection device 1140.

Herein, the object detection device 1140 may perform all or a portion of a function of a distance measurement device.

That is, in the present embodiment, the object detection device 1140 is a device for detecting an object located outside the moving object 1000, and the object detection device 1140 may detect the object located outside the moving object 1000 and generate object information according to the detection result.

The object information may include information on existence or nonexistence of the object, location information of the object, distance information between the moving object and the object, and relative speed information between the moving object and the object.

The object may include various objects located outside the moving object 1000, such as a lane, another vehicle, a pedestrian, a traffic signal, light, a road, a structure, a speed bump, a landform, an animal, and the like. Herein, the traffic signal may be a concept including a traffic signal, a traffic sign, a pattern or text drawn on a road surface. In addition, the light may be light generated from a lamp equipped in another vehicle, light generated from a streetlamp, or sunlight.

In addition, the structure may be an object located around a road and fixed to the ground. For example, the structure may include a streetlamp, a street tree, a building, a power pole, a traffic light, and a bridge. The landform may include a mountain, a hill, and the like.

Such the object detection device 1140 may include a camera module. The controller 1120 may extract object information from an external image captured by the camera module and enable the controller 1120 to process information thereon.

In addition, the object detection device 1140 may further include imaging devices for recognizing an external environment. RADAR, a GPS device, Odometry, and another computer vision device, an ultrasonic sensor, and an infrared sensor may be used, in addition to LIDAR, and these devices may be selected or operated simultaneously as needed to enable more precise detection.

Meanwhile, the distance measurement device according to an embodiment of the present invention may calculate a distance between the autonomous driving moving object 1000 and the object, and may control an operation of the moving object based on the distance calculated in connection with the control device 1100 of the autonomous driving moving object 1000.

As an example, in case that there is a probability of a collision according to the distance between the autonomous driving moving object 1000 and the object, the autonomous driving moving object 1000 may control a brake to lower a speed or stop. As another example, in case that the object is a moving object, the autonomous driving moving object 1000 may control a traveling speed of the autonomous driving moving object 1000 to maintain a predetermined distance or more from the object.

This distance measurement device according to an embodiment of the present invention may be configured as a module in the control device 1100 of the autonomous driving moving object 1000. That is, the memory 1122 and the processor 1124 of the control device 1100 may be configured to implement a collision prevention method according to the present invention in software.

In addition, the sensor 1110 may obtain various sensing information by connecting an internal/external environment of the moving object with the sensing modules 1004a, 1004b, 1004c, and 1004d. Herein, the sensor 1110 may include a posture sensor (e.g., a yaw sensor), a roll sensor, a pitch sensor, a collision sensor, a wheel sensor, a speed sensor, a tilt sensor, a weight detection sensor, a heading sensor, a gyro sensor, a position module, a moving object forward/rearward sensor, a battery sensor, a fuel sensor, a tire sensor, a steering sensor by handle rotation, a moving object internal temperature sensor, a moving object internal humidity sensor, an ultrasonic sensor, an illumination sensor, an accelerator pedal position sensor, a brake pedal position sensor, and the like.

Accordingly, the sensor 1110 may obtain sensing signals for moving object posture information, moving object collision information, moving object direction information, moving object location information (GPS information), moving object angle information, moving object speed information, moving object acceleration information, moving object tilt information, moving object forward/rearward information, battery information, fuel information, tire information, moving object lamp information, and moving object internal temperature information, moving object internal humidity information, a steering wheel rotation angle, moving object external illumination, a pressure applied to an accelerator pedal, a pressure applied to a brake pedal, and the like.

In addition, the sensor 1110 may further include an accelerator pedal sensor, a pressure sensor, an engine speed sensor, an air flow sensor (AFS), an intake air temperature sensor (ATS), a water temperature sensor (WTS), a throttle position sensor (TPS), a TDC sensor, a crank angle sensor (CAS), and the like.

As such, the sensor 1110 may generate moving object state information based on sensing data.

The wireless communication device 1130 is configured to implement wireless communication between the autonomous driving moving object 1000. For example, it enables the autonomous driving moving object 1000 to communicate with a mobile phone of a user, or the other wireless communication device 1130, another moving object, a central device (a traffic control device), a server, and the like. The wireless communication device 1130 may transmit and receive a wireless signal according to an access wireless protocol. A wireless communication protocol may be Wi-Fi, Bluetooth, Long-Term Evolution (LTE), Code Division Multiple Access (CDMA), Wideband Code Division Multiple Access (WCDMA), Global Systems for Mobile Communications (GSM), but the communication protocol is not limited thereto.

In addition, in the present embodiment, it is also possible for the autonomous driving moving object 1000 to implement communication between moving objects through the wireless communication device 1130. That is, the wireless communication device 1130 may perform communication with another moving object and other moving objects on the road through vehicle-to-vehicle (V2V) communication. The autonomous driving moving object 1000 may transmit and receive information such as driving warning and traffic information through the vehicle-to-vehicle (V2V) communication, and it is also possible to request information from, or receive a request from the other moving object. For example, the wireless communication device 1130 may perform the V2V communication as a dedicated short-range communication (DSRC) device or a Cellular-V2V (C-V2V) device. In addition, besides the vehicle-to-vehicle (V2V) communication, communication (e.g., Vehicle to Everything communication (V2X)) between a vehicle and another object (e.g., an electronic device carried by a pedestrian, and the like) may also be implemented through the wireless communication device 1130.

In addition, the wireless communication device 1130 may obtain information generated from various mobilities, including infrastructure (a traffic light, a CCTV, a RSU, a eNode B, and the like) located on the road or other autonomous driving/non-autonomous driving vehicles, and the like, through a non-terrestrial network other than a terrestrial network, as information for autonomous driving performance of the autonomous driving moving object 1000.

For example, the wireless communication device 1130 may perform wireless communication through a Low Earth Orbit (LEO) satellite system, a Medium Earth Orbit (MEO) satellite system, a Geostationary Orbit (GEO) satellite system, a High Altitude Platform (HAP) system, and the like, that configure a non-terrestrial network and an antenna dedicated to the non-terrestrial network mounted on the autonomous driving moving object 1000.

For example, the wireless communication device 1130 may perform wireless communication with various platforms configuring the NTN according to wireless access specifications of a 5TH Generation New Radio Non-Terrestrial Network (5G NR NTN) standard, which is currently discussed in 3GPP, and the like, but is not limited thereto.

In the present embodiment, the controller 1120 may select a platform that may properly perform NTN communication in consideration of various information such as a location of the autonomous driving moving object 1000, current time, and available power, and control the wireless communication device 1130 to perform wireless communication with the selected platform.

In the present embodiment, the controller 1120, which is a unit that controls an overall operation of each unit in the moving object 1000, may be configured by a manufacturer of the moving object when manufacturing or may be additionally configured to perform a function of autonomous driving after manufacturing. In addition, a configuration for performing a continuous additional function may be included through an upgrade of the controller 1120 configured when manufacturing. This controller 1120 may also be named an Electronic Control Unit (ECU).

The controller 1120 may collect various data from the connected sensor 1110, the object detection device 1140, the communication device 1130, and may transmit a control signal to the sensor 1110, the engine 1006, the user interface 1008, the communication device 1130, and the object detection device 1140 included in other components in the moving object based on the collected data. In addition, although not illustrated, the control signal may also be transmitted to an acceleration device, a braking system, a steering device, or a navigation device related to traveling of the moving object.

In the present embodiment, the controller 1120 may control the engine 1006, for example, may detect a speed limit of a road on which the autonomous driving moving object 1000 is traveling, and may control the engine 1006 so that a traveling speed does not exceed the speed limit or may control the engine 1006 to accelerate the traveling speed of the autonomous driving moving object 1000 in a range that does not exceed the speed limit.

In addition, when the autonomous driving moving object 1000 approaches a lane or leaves the lane while the autonomous driving moving object 1000 is traveling, the controller 1120 may determine whether such lane approaching and leaving are due to a normal traveling situation or another traveling situation, and may control the engine 1006 to control the traveling of the moving object according to the determination result. Specifically, the autonomous driving moving object 1000 may detect lanes formed on both sides of the lane in which the moving object is traveling. In this case, the controller 1120 may determine whether the autonomous driving moving object 1000 approaches the lane or leaves the lane, and if it is determined that the autonomous driving moving object 1000 approaches the lane or leaves the lane, the controller 1120 may determine whether this traveling is according to an accurate traveling situation or another traveling situation. Herein, as an example of the normal traveling situation, it may be a situation in which a lane change of the moving object is required. In addition, as an example of the other driving situations, it may be a situation in which a lane change of the moving object is not required. When it is determined that the autonomous driving moving object 1000 is approaching the lane or leaving the lane in a situation in which the moving object does not need to change lane, the controller 1120 may control the traveling of the autonomous driving moving object 1000 so that the autonomous driving moving object 1000 does not leave the lane and normally travels in a corresponding vehicle.

In case that another moving object or an obstacle exists in a front of the moving object, it may control the engine 1006 or the braking system to decelerate the driving moving object, and may control a trajectory, a traveling route, and a steering angle in addition to speed. Alternatively, the controller 1120 may control the traveling of the moving object by generating a necessary control signal according to recognition information of another external environment, such as a traveling lane or a driving signal of the moving object.

In addition to generating its own control signal, the controller 1120 may also control the traveling of the moving object by performing communication with a nearby moving object or a central server and transmitting a command to control peripheral devices through the received information.

In addition, since accurate recognition of the moving object or lane according to the present embodiment may be difficult in case that a location of the camera module 1150 changes or an angle of view changes, the controller 1120 may generate a control signal for controlling to perform calibration of the camera module 1150 to prevent this. Therefore, in the present embodiment, by generating the calibration control signal to the camera module 1150, the controller 1120 may continuously maintain a normal mounting location, a direction, an angle of view, and the like of the camera module 1150 even when a mounting location of the camera module 1150 is changed due to vibration or impact generated by a movement of the autonomous driving moving object 1000. In case that an initial mounting location, a direction, and an angle of view information of the camera module 1150 that are pre-stored, and an initial mounting location, a direction, an angle of view information, and the like of the camera module 1150 measured while the autonomous driving moving object 1000 is traveling are changed by a threshold value or more, the controller 1120 may generate the control signal to perform the calibration of the camera module 1150.

In the present embodiment, the controller 1120 may include the memory 1122 and the processor 1124. The processor 1124 may execute software stored in the memory 1122 according to the control signal of the controller 1120. Specifically, the controller 1120 may store data and commands for performing the lane detection method according to the present invention in the memory 1122, and the commands may be executed by the processor 1124 to implement one or more methods disclosed herein.

In this case, the memory 1122 may be a non-volatile recording medium executable by the processor 1124. The memory 1122 may store software and data through an appropriate internal/external device. The memory 1122 may be configured with random access memory (RAM), read only memory (ROM), a hard disk, and a memory 1122 device connected with a dongle.

The memory 1122 may at least store an Operating system (OS), a user application, and executable commands. The memory 1122 may also store application data and array data structures.

The processor 1124, which is a microprocessor or an appropriate electronic processor, may be a controller, a microcontroller, or a state machine.

The processor 1124 may be implemented as a combination of computing devices, and the computing device may be configured with a digital signal processor, a microprocessor, or an appropriate combination thereof.

Meanwhile, the autonomous driving moving object 1000 may further include the user interface 1008 for a user input with respect to the above-described control device 1100. The user interface 1008 may enable a user to input information with appropriate interaction. For example, it may be implemented as a touch screen, a keypad, or an operation button, and the like. The user interface 1008 may transmit an input or a command to the controller 1120, and the controller 1120 may perform a control operation of the moving object in response to the input or the command.

In addition, the user interface 1008, which is a device outside the autonomous driving moving object 1000, may perform communication with the autonomous driving moving object 1000 through the wireless communication device 1130. For example, the user interface 1008 may be linkable with a mobile phone, a tablet, or another computer device.

Furthermore, in the present embodiment, the autonomous driving moving object 1000 has been described as including the engine 1006, but it may also include another type of a propulsion system. For example, the moving object may be operated with electrical energy, and may be operated through hydrogen energy or a hybrid system combining them. Therefore, the controller 1120 may include a propulsion mechanism according to the propulsion system of the autonomous driving moving object 1000 and may provide a control signal according to this to components of each propulsion mechanism.

Hereinafter, a detailed configuration of the control device 1100 according to the present invention according to the present embodiment will be described in more detail with reference to FIG. 11.

A control device 1100 includes a processor 1124. The processor 1124 may be a general-purpose single or multi-chip microprocessor, a dedicated microprocessor, a microcontroller, a programmable gate array, and the like. The processor may be referred to as a central processing unit (CPU). In addition, in the present embodiment, it is possible that the processor 1124 is used as a combination of a plurality of processors.

The control device 1100 also includes memory 1122. The memory 1122 may be any electronic component capable of storing electronic information. The memory 1122 may also include a combination of the memories 1122 in addition to single memory.

Data and commands 1122a for performing a distance measuring method of a distance measuring device according to the present invention may be stored in the memory 1122. When the processor 1124 executes the commands 1122a, all or a portion of the commands 1122a and the data 1122 b required for performing a command may be loaded 1124a and 1124b onto the processor 1124.

The control device 1100 may include a transmitter 1130a, a receiver 1130b, or a transceiver 1130c for permitting transmission and reception of signals. One or more antennas 1132a and 1132b may be electrically connected to the transmitter 1130a, the receiver 1130b, or each transceiver 1130c, and may further include antennas.

The control device 1100 may include a digital signal processor (DSP) 1170. Through the DSP 1170, the digital signal may be quickly processed by a moving object.

The control device 1100 may include a communication interface 1180. The communication interface 1180 may include one or more ports and/or communication modules for connecting other devices to the control device 1100. The communication interface 1180 may enable a user and the control device 1100 to interact with each other.

Various configurations of the control device 1100 may be connected together by one or more buses 1190, and the buses 1190 may include a power bus, a control signal bus, a state signal bus, a data bus, and the like. Under a control of the processor 1124, configurations may transmit mutual information through the bus 1190 and perform a desired function.

Meanwhile, in various embodiments, the control device 1100 may be related to a gateway for communication with a security cloud. For example, referring to FIG. 12, the control device 1100 may be related to a gateway 1205 for providing information obtained from at least one of components 1001 to 1004 of a vehicle 1200 to a security cloud 1206. For example, the gateway 1205 may be included in the control device 1100. For another example, the gateway 1205 may be configured as a separate device in the vehicle 1200 that is distinguished from the control device 1100. The gateway 1205 connects a network in the vehicle 1200 secured by a software management cloud 1209, the security cloud 1206, and in-car security software 1210, having different networks, to enable communication.

For example, a component 1201 may be a sensor. For example, the sensor may be used to obtain information on at least one of a state of the vehicle 1200 or a state around the vehicle 1200. For example, the component 1201 may include a sensor 1110.

For example, a component 1202 may be electronic control units (ECUs). For example, the ECUs may be used for engine control, transmission control, airbag control, and tire pressure management.

For example, a component 1203 may be an instrument cluster. For example, the instrument cluster may mean a panel located in a front of a driver's seat among dashboards. For example, the instrument cluster may be configured to display information necessary for driving to a driver (or a passenger). For example, the instrument cluster may be used to display at least one of visual elements for indicating a revolutions per minute (or rotates per minute) (RPM) of the engine, visual elements for indicating a speed of the vehicle 1200, visual elements for indicating an amount of remaining fuel, visual elements for indicating a state of a gear, or visual elements for indicating information obtained through the component 1201.

For example, a component 1204 may be a telematics device. For example, the telematics device may mean a device that provides various mobile communication services, such as location information and safe driving in the vehicle 1200 by coupling wireless communication technology and global positioning system (GPS) technology. For example, the telematics device may be used to connect the vehicle 1200 with a driver, a cloud (e.g., the security cloud 1206), and/or a surrounding environment. For example, the telematics device may be configured to support high bandwidth and low latency for 5G NR-standard technology (e.g., V2X technology of the 5G NR, Non-Terrestrial Network (NTN) technology of the 5G NR). For example, the telematics device may be configured to support autonomous driving of the vehicle 1200.

For example, the gateway 1205 may be used to connect a network within the vehicle 1200, and the software management cloud 1209 and the secure cloud 1206, which are a network outside the vehicle. For example, the software management cloud 1209 may be used to update or manage at least one software necessary for traveling and managing the vehicle 1200. For example, the software management cloud 1209 may be linked to the in-car security software 1210 installed in the vehicle. For example, the in-car security software 1210 may be used to provide a security function in the vehicle 1200. For example, the in-car security software 1210 may encrypt data transmitted and received through an in-car network using an encryption key obtained from an external authorized server for encryption of the in-car network. In various embodiments, the encryption key used by the in-car security software 1210 may be generated corresponding to vehicle identification information (a vehicle license plate, a vehicle identification number (VIN)) or information (e.g., user identification information) uniquely assigned to each user.

In various embodiments, the gateway 1205 may transmit the data encrypted by the in-car security software 1210 based on the encryption key to the software management cloud 1209 and/or the security cloud 1206. The software management cloud 1209 and/or the security cloud 1206 may identify the data received from which vehicle or which user by decrypting the data encrypted by the encryption key of the in-car security software 1210. For example, since the decryption key is a unique key corresponding to the encryption key, the software management cloud 1209 and/or the security cloud 1206 may identify a transmission entity (e.g., the vehicle or the user) of the data based on the data decrypted through the decryption key.

For example, the gateway 1205 may be configured to support in-car security software 1210 and may be related to the control device 1100. For example, the gateway 1205 may be related to the control device 1100 to support a connection between a client device 1207 and the control device 1100 connected to the security cloud 1206. For another example, the gateway 1205 may be related to the control device 1100 to support a connection between a third-party cloud 1208 connected to the security cloud 1206 and the control device 1100. However, it is not limited thereto.

In various embodiments, the gateway 1205 may be used to connect the vehicle 1200 with the software management cloud 1209 to manage operating software of the vehicle 1200. For example, the software management cloud 1209 may monitor whether updating the operating software of the vehicle 1200 is required, and based on monitoring that the updating the operating software of the vehicle 1200 is required, provide data for the updating the operating software of the vehicle 1200 through the gateway 1205. For another example, the software management cloud 1209 may receive a user request for updating the operating software of the vehicle 1200 from the vehicle 1200 through the gateway 1205, and provide data for updating the operating software of the vehicle 1200 based on the reception. However, it is not limited thereto.

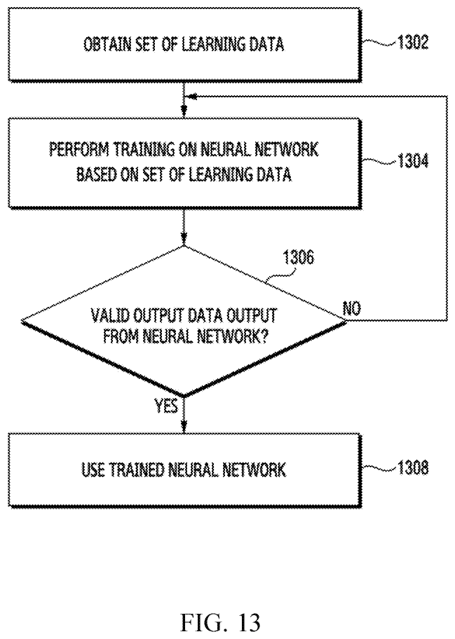

FIG. 13 is a diagram for explaining an operation of an electronic device for training a neural network based on a set of learning data, according to an embodiment.

An operation described with reference to FIG. 13 may be performed by the above-described electronic device (e.g., the electronic device 100 of FIG. 1).

Referring to FIG. 13, in operation 1302, the electronic device may obtain the set of the learning data according to an embodiment. The electronic device may obtain the set of the learning data for supervised learning. The learning data may include a pair of input data and ground truth data corresponding to the input data. The ground truth data may indicate output data to be obtained from the neural network that has received the input data, which is the pair of the ground truth data. The ground truth data may be obtained by the electronic device described above.

For example, in case of training the neural network for image recognition, the learning data may include information regarding an image and one or more subjects included within the image. The information may include a category (or a class) of a subject identifiable through the image. The information may include a location, a width, a height, and/or a size of a visual object corresponding to the subject within the image. The set of the learning data identified through the operation 1302 may include pairs of a plurality of learning data. In the example of training the neural network for the image recognition, the set of the learning data identified by the electronic device may include a plurality of images and ground truth data corresponding to each of the plurality of images.

Referring to FIG. 13, in operation 1304, the electronic device according to an embodiment may perform training on the neural network based on the set of the learning data. In an embodiment in which the neural network is trained based on the supervised learning, the electronic device may input the input data included in the learning data to an input layer of the neural network. An example of the neural network including the input layer will be described with reference to FIG. 15. From an output layer of the neural network receiving the input data through the input layer, the electronic device may obtain output data of the neural network corresponding to the input data.

In an embodiment, the training of the operation 1304 may be performed based on a difference between the output data and the ground truth data included in the learning data and corresponding to the input data. For example, the electronic device may adjust one or more parameters related to the neural network to reduce the difference based on a gradient descent algorithm. An operation of the electronic device adjusting the one or more parameters may be referred to as tuning for the neural network. The electronic device may perform the tuning of the neural network based on the output data using a function defined to evaluate performance of the neural network, such as a cost function. The difference between the output data and the ground truth data may be included as an example of the cost function.

Referring to FIG. 13, in operation 1306, according to an embodiment, the electronic device may identify whether valid output data is outputted from the neural network trained by the operation 1304. The output data being valid may mean that the difference (or the cost function) between the output data and the ground truth data satisfies a condition set for use of the neural network. For example, in case that an average value and/or the maximum value of the difference between the output data and the ground truth data is less than or equal to a designated threshold value, the electronic device may determine that the valid output data is outputted from the neural network.

In case that the valid output data is not outputted from the neural network (1306—NO), the electronic device may repeatedly perform training of the neural network based on the operation 1304. An embodiment is not limited thereto, and the electronic device may repeatedly perform the operations 1302 and 1304.

In a state in which the valid output data is obtained from the neural network (1306—YES), based on operation 1308, the electronic device according to an embodiment may use the trained neural network. For example, the electronic device may input other input data to the neural network that is distinct from the input data inputted to the neural network as the learning data. The electronic device may use output data obtained from the neural network receiving the other input data as a result of performing inference on the other input data based on the neural network.

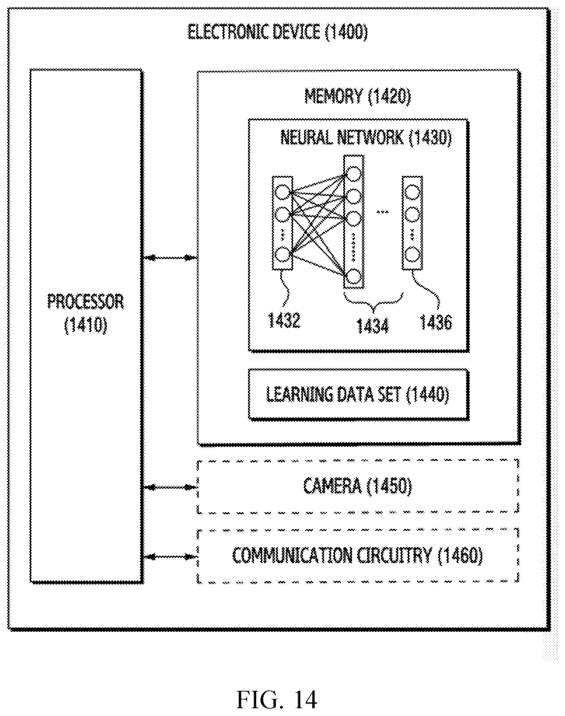

FIG. 14 is a block diagram of an electronic device according to an embodiment.

An electronic device 1400 of FIG. 14 may include the above-described electronic device.

For example, an operation described with reference to FIG. 13 may be performed by the electronic device 1400 of FIG. 14 and/or a processor 1410 of FIG. 14.

Referring to FIG. 14, the processor 1410 of the electronic device 1400 may perform computations related to a neural network 1430 stored in memory 1420. The processor 1410 may include at least one of a center processing unit (CPU), a graphic processing unit (GPU), and a neural processing unit (NPU). The NPU may be implemented as a chip separated from the CPU, or integrated into a chip such as the CPU in a form of a system on a chip (SoC). The NPU integrated into the CPU may be referred to as a neural core and/or an artificial intelligence (AI) accelerator.

Referring to FIG. 14, the processor 1410 may identify the neural network 1430 stored in the memory 1420. The neural network 1430 may include a combination of an input layer 1432, one or more hidden layers 1434 (or intermediate layers), and an output layer 1436. The above-described layers (e.g., the input layer 1432, the one or more hidden layers 1434, and the output layer 1436) may include a plurality of nodes. The number of hidden layers 1434 may vary according to an embodiment, and the neural network 1430 including the plurality of hidden layers 1434 may be referred to as a deep neural network. An operation of training the deep neural network may be referred to as deep learning.

In an embodiment, in case that the neural network 1430 has a structure of a feed forward neural network, a first node included in a specific layer may be connected to all of second nodes included in another layer before the specific layer. In the memory 1420, parameters stored for the neural network 1430 may include weights assigned to connections between the second nodes and the first node. In the neural network 1430 having the structure of the feed forward neural network, a value of the first node may correspond to a weighted sum of values assigned to the second nodes, based on the weights assigned to the connections connecting the second nodes and the first node.

In an embodiment, in case that the neural network 1430 has a structure of a convolutional neural network, the first node included in the specific layer may correspond to a weighted sum of a portion of the second nodes included in the other layer before the specific layer. The portion of the second nodes corresponding to the first node may be identified by a filter corresponding to the specific layer. In the memory 1420, the parameters stored for the neural network 1430 may include weights indicating the filter. The filter may include, among the second nodes, one or more nodes to be used to calculate a weighted sum of the first node, and weights corresponding to each of the one or more nodes.

According to an embodiment, the processor 1410 of the electronic device 1400 may perform training on the neural network 1430 using a learning data set 1440 stored in the memory 1420. Based on the learning data set 1440, the processor 1410 may adjust one or more parameters stored in the memory 1420 for the neural network 1430 by performing the operation described with reference to FIG. 13.

According to an embodiment, the processor 1410 of the electronic device 1400 may perform object detection, object recognition, and/or object classification using the neural network 1430 trained based on the learning data set 1440. The processor 1410 may input an image (or a video) obtained through a camera 1450 into the input layer 1432 of the neural network 1430. Based on the input layer 1432 to which the image is inputted, the processor 1410 may obtain a set (e.g., the output data) of values of the nodes of the output layer 1436 by sequentially obtaining values of the nodes of the layers included in the neural network 1430. The output data may be used as a result of inferring information included in the image using the neural network 1430. An embodiment is not limited thereto, and the processor 1410 may input an image (or a video) obtained from an external electronic device connected to the electronic device 1400 through communication circuitry 1460 to the neural network 1430.

In an embodiment, the neural network 1430 trained to process an image may be used to identify a region corresponding to a subject within the image (object detection), and/or to identify a class of the subject represented within the image (object recognition and/or object classification). For example, the electronic device 1400 may segment the region corresponding to the subject within the image based on a quadrangle shape such as a bounding box, using the neural network 1430. For example, the electronic device 1400 may identify at least one class matching the subject among a plurality of designated classes using the neural network 1430.

An electronic device is described. The electronic device may be mounted on a vehicle. The electronic device may comprise a camera configured to be disposed to face an interior of the vehicle, memory, and a processor. The processor may be configured to cause the electronic device to obtain a video via the camera, identify a visual object by performing object recognition on the video, based on identifying the visual object corresponding to an external object of a designated category, determine a reference position of the visual object within the video, while obtaining the video, identify whether the reference position which is tracked from the video is located outside a safety area that defines the interior of the vehicle, and output an alarm related to the external object based on identifying that the reference position of the visual object is located outside the safety area.

For example, the reference position of the visual object may correspond to a center of mass of the visual object.

For example, the electronic device may further comprise a speaker, and the processor may be configured to cause the electronic device to, based on identifying that the reference position of the visual object is located outside the safety area, output the alarm via the speaker.

For example, the processor may be configured to cause the electronic device to, based on identifying that the reference position of the visual object is located outside the safety area, reduce a speed of the vehicle.

For example, the visual object may correspond to a person captured by the camera.

For example, the electronic device may further comprise a communication circuit, and the processor may be configured to cause the electronic device to, based on outputting the alarm related to the external object, identify whether an event has occurred with respect to the visual object by analyzing the video, and based on identifying that the event has occurred with respect to the visual object, transmit data related to the event to an external electronic device via the communication circuit.

For example, the camera may be an internal camera, the electronic device may further comprise an external camera configured to be disposed to face an exterior of the vehicle, and the processor may be configured to cause the electronic device to obtain the video via the internal camera and the external camera.

For example, the processor may be configured to cause the electronic device to identify whether the event has occurred with respect to the visual object by executing a trained model.

A method is described. The method may be executed by an electronic device mountable on a vehicle and comprising a camera configured to be disposed to face an interior of the vehicle, memory, and a processor. The method may comprise obtaining a video via the camera, identifying a visual object by performing object recognition on the video, based on identifying the visual object corresponding to an external object of a designated category, determining a reference position of the visual object within the video, while obtaining the video, identifying whether the reference position which is tracked from the video is located outside a safety area that defines the interior of the vehicle, and outputting an alarm related to the external object based on identifying that the reference position of the visual object is located outside the safety area.

For example, the reference position of the visual object may correspond to a center of mass of the visual object.

For example, the electronic device may further include a display configured to display an image and a third processor, which is a central processing unit (CPU).

For example, the electronic device may further comprise a speaker, and the method may further comprise, based on identifying that the reference position of the visual object is located outside the safety area, outputting the alarm via the speaker.

For example, the method may further comprise, based on identifying that the reference position of the visual object is located outside the safety area, reducing a speed of the vehicle.

For example, the visual object may correspond to a person captured by the camera.

For example, the electronic device may further comprise a communication circuit, and the method may further comprise, based on outputting the alarm related to the external object, identifying whether an event has occurred with respect to the visual object by analyzing the video, and based on identifying that the event has occurred with respect to the visual object, transmitting data related to the event to an external electronic device via the communication circuit.

For example, the camera may be an internal camera, the electronic device may further comprise an external camera configured to be disposed to face an exterior of the vehicle, and the method may further comprise obtaining the video via the internal camera and the external camera.

For example, the method may further comprise identifying whether the event has occurred with respect to the visual object by executing a trained model.

A non-transitory computer-readable storage medium is described. The non-transitory computer-readable storage medium may store one or more programs. The one or more programs may be executed by an electronic device mountable on a vehicle and comprising a camera configured to be disposed to face an interior of the vehicle, memory, and a processor. The one or more programs may include instructions that cause the electronic device to obtain a video via the camera, identify a visual object by performing object recognition on the video, based on identifying the visual object corresponding to an external object of a designated category, determine a reference position of the visual object within the video, while obtaining the video, identify whether the reference position which is tracked from the video is located outside a safety area that defines the interior of the vehicle, and output an alarm related to the external object based on identifying that the reference position of the visual object is located outside the safety area.

For example, the reference position of the visual object may correspond to a center of mass of the visual object.

For example, the electronic device may further comprise a speaker, and the one or more programs may include instructions that cause the electronic device to, based on identifying that the reference position of the visual object is located outside the safety area, output the alarm via the speaker.

For example, the one or more programs may include instructions that cause the electronic device to, based on identifying that the reference position of the visual object is located outside the safety area, reduce a speed of the vehicle.

The technical problems to be achieved in the present disclosure are not limited to those described above, and other technical problems not mentioned herein will be clearly understood by those having ordinary knowledge in the art to which the present disclosure belongs.

1. An electronic device mountable on a vehicle, comprising:
a camera configured to be disposed to face an interior of the vehicle;
memory; and
a processor,
wherein the processor is configured to cause the electronic device to:
obtain a video via the camera;
identify a visual object by performing object recognition on the video;
based on identifying the visual object corresponding to an external object of a designated category, determine a reference position of the visual object within the video;
while obtaining the video, identify whether the reference position which is tracked from the video is located outside a safety area that defines the interior of the vehicle; and
output an alarm related to the external object based on identifying that the reference position of the visual object is located outside the safety area.

2. The electronic device of claim 1,
wherein the reference position of the visual object corresponds to a center of mass of the visual object.

3. The electronic device of claim 1 further comprising a speaker,
wherein the processor is configured to cause the electronic device to,
based on identifying that the reference position of the visual object is located outside the safety area, output the alarm via the speaker.

4. The electronic device of claim 1,
wherein the processor is configured to cause the electronic device to,
based on identifying that the reference position of the visual object is located outside the safety area, reduce a speed of the vehicle.

5. The electronic device of claim 1,
wherein the visual object corresponds to a person captured by the camera.

6. The electronic device of claim 1 further comprising a communication circuit,
wherein the processor is configured to cause the electronic device to:
based on outputting the alarm related to the external object, identify whether an event has occurred with respect to the visual object by analyzing the video; and
based on identifying that the event has occurred with respect to the visual object, transmit data related to the event to an external electronic device via the communication circuit.

7. The electronic device of claim 6,
wherein the camera is an internal camera,
wherein the electronic device further comprises an external camera configured to be disposed to face an exterior of the vehicle, and
wherein the processor is configured to cause the electronic device to obtain the video via the internal camera and the external camera.

8. The electronic device of claim 6,
wherein the processor is configured to cause the electronic device to identify whether the event has occurred with respect to the visual object by executing a trained model.

9. A method executed by an electronic device mountable on a vehicle and comprising a camera configured to be disposed to face an interior of the vehicle, memory, and a processor, the method comprising:
obtaining a video via the camera;
identifying a visual object by performing object recognition on the video;
based on identifying the visual object corresponding to an external object of a designated category, determining a reference position of the visual object within the video;
while obtaining the video, identifying whether the reference position which is tracked from the video is located outside a safety area that defines the interior of the vehicle; and
outputting an alarm related to the external object based on identifying that the reference position of the visual object is located outside the safety area.

10. The method of claim 9, wherein the reference position of the visual object corresponds to a center of mass of the visual object.

11. The method of claim 9, wherein the electronic device further comprises a speaker, and
wherein the method further comprises:
based on identifying that the reference position of the visual object is located outside the safety area, outputting the alarm via the speaker.

12. The method of claim 9 further comprising:
based on identifying that the reference position of the visual object is located outside the safety area, reducing a speed of the vehicle.

13. The method of claim 9, wherein the visual object corresponds to a person captured by the camera.

14. The method of claim 9, wherein the electronic device further comprises a communication circuit, and
wherein the method further comprises:
based on outputting the alarm related to the external object, identifying whether an event has occurred with respect to the visual object by analyzing the video; and
based on identifying that the event has occurred with respect to the visual object, transmitting data related to the event to an external electronic device via the communication circuit.

15. The method of claim 14,
wherein the camera is an internal camera,
wherein the electronic device further comprises an external camera configured to be disposed to face an exterior of the vehicle, and
wherein the method further comprises:
obtaining the video via the internal camera and the external camera.

16. The method of claim 14 further comprising:
identifying whether the event has occurred with respect to the visual object by executing a trained model.

17. A non-transitory computer-readable storage medium storing one or more programs, wherein the one or more programs include instructions that, when executed by an electronic device mountable on a vehicle and comprising a camera configured to be disposed to face an interior of the vehicle, memory, and a processor, cause the electronic device to:
obtain a video via the camera;
identify a visual object by performing object recognition on the video;
based on identifying the visual object corresponding to an external object of a designated category, determine a reference position of the visual object within the video;
while obtaining the video, identify whether the reference position which is tracked from the video is located outside a safety area that defines the interior of the vehicle; and
output an alarm related to the external object based on identifying that the reference position of the visual object is located outside the safety area.

18. The non-transitory computer-readable storage medium of claim 17,
wherein the reference position of the visual object corresponds to a center of mass of the visual object.

19. The non-transitory computer-readable storage medium of claim 17,
wherein the electronic device further comprises a speaker, and
wherein the one or more programs include instructions that, when executed by the electronic device, cause the electronic device to,
based on identifying that the reference position of the visual object is located outside the safety area, output the alarm via the speaker.

20. The non-transitory computer-readable storage medium of claim 17,
wherein the one or more programs include instructions that, when executed by the electronic device, cause the electronic device to,
based on identifying that the reference position of the visual object is located outside the safety area, reduce a speed of the vehicle.
